(19) United States
(12) Patent Application Publication
(10) Pub. No.: US 2024/0096133 A1
(43) Pub. Date: Mar. 21, 2024

(54) METHOD AND SYSTEM FOR GENERATING AN IMAGE OF AN OCULAR PORTION

(71) Applicant: Samsung Electronics Co., Ltd., Suwon-si, Gyeonggi-do (KR)

(72) Inventors: Vijay Narayan TIWARI, Bengaluru (IN); Ankur TRISAL, Bengaluru (IN); Dewanshu HASWANI, Bengaluru (IN); Ashish GOYAL, Bengaluru (IN)

(21) Appl. No.: 18/512,693

(22) Filed: Nov. 17, 2023

Related U.S. Application Data
(63) Continuation of application No. PCT/KR2023/008920, filed on Jun. 27, 2023.

(30) Foreign Application Priority Data
Jul. 11, 2022 (IN) 202241039820

(51) Int. Cl. G06V 40/18; G01S 7/41; G01S 13/89; G06T 7/60; G06T 7/70; G06V 40/19

(52) U.S. Cl. CPC G06V 40/197; G01S 7/412; G01S 13/89; G06T 7/60; G06T 7/70; G06V 40/19; G06T 2207/10028; G06T 2207/30201

(57) ABSTRACT

A method and a system for image capturing of an eye are provided. The image capturing method in an electronic device includes directing radar signals on one or more portions of the eye that is required to be captured, determining an amount of signals absorbed into one or more portions of the eye by measuring the amount of signals reflected by one or more portions of the eye and estimating size of one or more portions of the eye based on the amount of signals absorbed, and generating an image of the eye having the portions with the estimated sizes.

### CROSS-REFERENCE TO RELATED APPLICATION(S)

This application is a continuation application, claiming priority under § 365(c), of an International application No. PCT/KR2023/008920, filed on Jun. 27, 2023, which is based on and claims the benefit of an Indian patent application number 202241039820, filed on Jul. 11, 2022, in the Indian Patent Office, the disclosure of which is incorporated by reference herein in its entirety.

### TECHNICAL FIELD

The disclosure relates to a method and system for image capturing of an eye. More particularly, the disclosure relates to a method for generating an image of an ocular portion of an eye by an electronic device.

### BACKGROUND ART

Recently, various camera technology is used for generating an image of an eye for various applications. The applications may include, but are not limited to, biometric authentication, smartphones, eye gaze tracking, and the like. However, the methods of the related art based on vision (camera) may have issues related to limited field of view, power consumption and privacy issues. Furthermore, these methods often require frequent calibrations in order to provide best accuracies. Vision based technologies further dependent on lighting conditions.

In particular, camera technology utilizes many sensors that require complex calibration methods for generating the image of the eye. Therefore, due to the requirement of the complex calibration by the sensors, it fails to accurately generate the image of the eye.

Further, the positioning of the sensors in an electronic device is generally fixed. Due to this, it is difficult to capture an image of the eye from a wide view of angle. Thus, there is always field of view (FOV) issues in conventional art while capturing the image of an eye. Therefore, it fails to generate the image of the eye accurately.

Furthermore, the user may wear glasses during an authenticating process. In this case, imaging of the eye via the glasses fails to capture the image of the eye with the required precision. Further, the related art fails to capture the image of the eye when the eyelids are closed. Therefore, the methods of the related art fail to generate the image of the eye accurately.

Accordingly, various issues related to the conventional (Camera based) method may be gathered as below:
complex calibration,
privacy issue in camera based methods,
field of view (FOV) issue,
fails to capture the image of the eye while wearing glass or with closed eye lids.

Thus, as can be seen, there is a need to provide a methodology to overcome above-mentioned issues.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a method and system for image capturing of an eye.

Additional aspects will be set forth in part in the description which follows and, in part, will be apparent from the description, or may be learned by practice of the presented embodiments.

In accordance with an aspect of the disclosure, an image capturing method in an electronic device is provided. The image capturing method includes outputting a radar signal on one or more portions of a user's eye, receiving an amount of signals reflected by one or more portions corresponding to the eye, obtaining a size of one or more portions corresponding to the eye based on the received amount of signals and obtaining an image corresponding to the eye having the portions with the estimated sizes.

The outputting of the radar signal on one or more portions of the eye includes outputting the radar signal on the one or more portions corresponding to the eye through at least one sensor that is included in the electronic device. The one or more portions includes a plurality of layers.

The receiving of the amount of signals includes receiving the amount of each of signals reflected by each layer of the plurality of layers in the one or more portions. The obtaining of the size of one or more portions corresponding to the eye includes obtaining a time difference between at least two consecutive reflected signals based on the received the amount of each of signals and identifying a thickness of each layer of the plurality of layers in the one or more portions based on the time difference between the at least two consecutive reflected signals.

The method may include determining whether the user is in a predefined range of the electronic device based on a sensor data. The radar signal may be output on the one or more portions corresponding to the eye in response to the determination that the user is within the predefined range of the electronic device.

The radar signal may include at least one of high frequency radio waves and ultrawide band (UWB) waves.

The obtaining of the image corresponding to the eye may include classifying each layer from the plurality of layers of the one or more portions based on the estimated size of each layer of the one or more portions, obtaining a sub image corresponding to each layer among the plurality of layers based on the classification and obtaining the image corresponding to the eye by combining the sub image corresponding to each layer.

The method may include obtaining a similarity value between the image corresponding to the eye and a pre-stored image of one or more portions corresponding the eye, comparing the similarity value with a predefined threshold value and authenticating the user based on the comparison.

The image corresponding to the eye may be a first image and the method may include capturing a second image corresponding to a head of the user through an imaging sensor included in the electronic device, determining an angle of orientation corresponding the head based on the second image corresponding to the head, determining a line of sight corresponding to the eye based on the determined angle of orientation corresponding to the head and the first image of the one or more portions corresponding to the eye and determining a gaze direction corresponding to the eye based on the determined angle of orientation corresponding the head and the determined line of sight of corresponding to the eye.

The one or more portions corresponding to the eye may include an ocular portion of the eye.

The ocular portion may include a plurality of layers in the ocular portion of the eye.

In accordance with another aspect of the disclosure, an electronic device is provided. The electronic device includes at least one sensor and at least one processor. The at least one processor is configured to, through the at least one sensor, output radar signal on one or more portions of a user's eye, through the at least one sensor, receive an amount of signals reflected by one or more portions corresponding to the eye, obtain a size of one or more portions corresponding to the eye based on the received amount of signals and obtain an image corresponding to the eye having the portions with the obtained sizes.

The at least one processor may be configured to, through the at least one sensor, output the radar signal on the one or more portions of the eye through at least one sensor that is included in the electronic device. The one or more portions may include a plurality of layers.

The at least one processor may, through the at least one sensor, receive the amount of each of the signals reflected by each layer of the plurality of layers in the one or more portions, obtain a time difference between at least two consecutive reflected signals based on the received the amount of each of signals and identify a thickness of each layer of the plurality of layers in the one or more portions based on the time difference between the at least two consecutive reflected signals.

The at least one processor may determine whether the user is in a predefined range of the electronic device based on a sensor data. The radar signal may be output on the one or more portions corresponding to the eye in response to the determination that the user is within the predefined range of the electronic device.

The radar signal may include at least one of high frequency radio waves and ultrawide band (UWB) waves.

In an implementation, the disclosure relates to a method and system for image capturing of an eye. According to one embodiment, the disclosure provides an image capturing method in an electronic device, that includes directing radar signals on one or more portions of the eye that is required to be captured. Then, determining an amount of signals absorbed into one or more portions of the eye by measuring the amount of signals reflected by one or more portions of the eye and estimating size of one or more portions of the eye based on the amount of signals absorbed. Thereafter, generating an image of the eye having the portions with the estimated sizes.

In accordance with another aspect of the disclosure, a method for generating an image of an ocular portion of an eye by an electronic device is provided. The method includes transmitting radar waves on an ocular portion of the user's eye via at least one sensor that is included in the electronic device, wherein the ocular portion includes a plurality of layers in the ocular portion of the user's eye. Thereafter, measuring an amount of each of signals reflected by each layer of the plurality of layers in the ocular portion and a thickness of each layer of the plurality of layers in the ocular portion in response to the transmitted radar waves based on a time difference between at least two consecutive reflected signals. Thereafter, the method determines an amount of the transmitted radar waves that are absorbed by each layer of the plurality of layers of the ocular portion based on the measured amount of each of the reflected signals and estimate a size of each layer of the plurality of layers in the ocular portion based on the determined amount of transmitted radar waves that are absorbed by each layer of the plurality of layers in the ocular portion. Thus, the method generates the image of the ocular portion of the user's eye with the estimated size of each layer of the ocular region.

Other aspects, advantages, and salient features of the disclosure will become apparent to those skilled in the art from the following detailed description, which, taken in conjunction with the annexed drawing, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 illustrates a relation of a dielectric constant and a frequency for various organs according to an embodiment of the disclosure;

FIG. 2 illustrates a block diagram of an electronic device implemented with an image capturing method, according to an embodiment of the disclosure;

FIG. 3 illustrates an overall working of the imaging mechanism of the eye, according to an embodiment of the disclosure;

FIG. 4 shows various portions of user's eye according to an embodiment of the disclosure;

FIG. 5 illustrates thickness of various portions of the eye, according to an embodiment of the disclosure;

FIG. 6A illustrates relation between relative permittivity and of the eye tissue according to an embodiment of the disclosure;

FIG. 6B shows a relation between relative permittivity of the eye tissues at 3.0 and 10 GHz vs depth inside an eye is shown, according to an embodiment of the disclosure;

FIG. 7 illustrates a graph between electric filed and the reflected wave ΔT, according to an embodiment of the disclosure;

FIG. 8 illustrates an embodiment for biometric authentication, according to an embodiment of the disclosure;

FIG. 9 illustrates an embodiment for determining a gaze direction, according to an embodiment of the disclosure;

FIG. 10 illustrates an operational flow chart for generating an image of an ocular portion, according to an embodiment of the disclosure; and

FIG. 11 illustrates an operational flow chart for image capturing method, according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skill in the art.

Embodiments of the disclosure will be described below in detail with reference to the accompanying drawings.

The disclosure provides a unique methodology for imaging an eye by utilizing Ultra-Wide Band (UWB) radar waves. Ultra-wideband (UWB) is a short-range, wireless communication protocol that operates through radio waves. UWB operates at very high frequencies—a broad spectrum of GHz frequencies and can be used to capture highly accurate spatial and directional data. Using UWB radar reflected waves a permittivity of tissue, skin and the like may be determined.

The permittivity of organs varies for different body tissues. For example, the pre permittivity of blood, bone, heart, and kidney varies from each other.

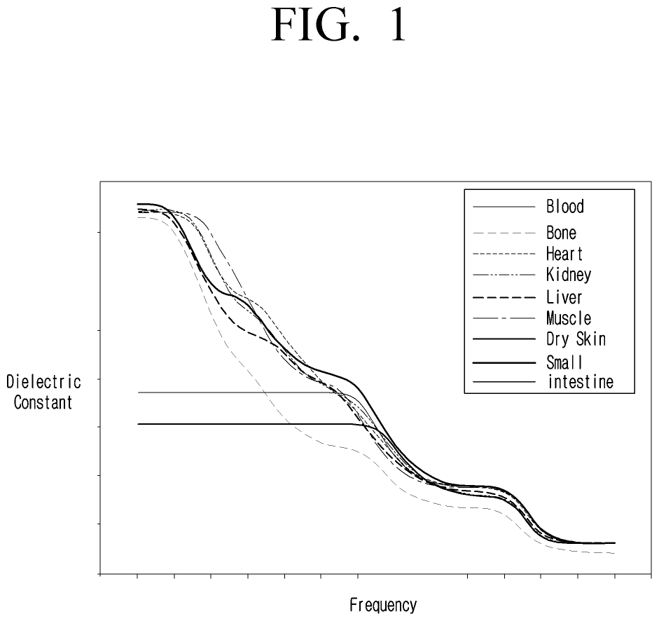

FIG. 1 illustrates a relation between a dielectric constant and a frequency for various organs according to an embodiment of the disclosure.

Referring to FIG. 1, if the permittivity of each of the organs can be calculated, then by using the permittivity an image of that organ can be generated. The UWB radar waves may be utilized for estimating the permittivity (di-electric constant) [ε].

Accordingly, the UWB radar waves provide:
Identification of body part using permittivity, [ε].
Proximity related to that part [d(x,y)].
Using multi-channel sensors an angle of arrival [⊖] may be calculated.

Thus, by combining the above information the eyeball may be reconstructed and localized.

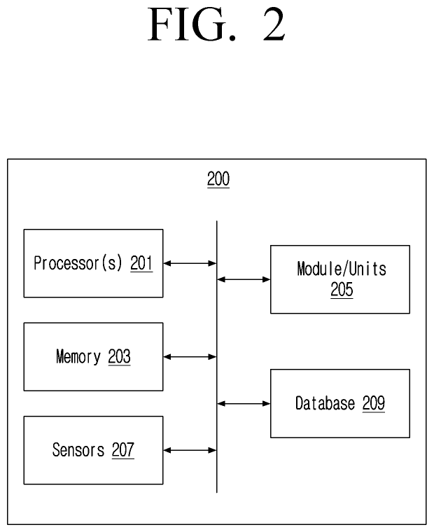

FIG. 2 illustrates a block diagram of an electronic device 200 implemented with an image capturing method, according to an embodiment of the disclosure. FIG. 2 shows the electronic device 200 for generating an image of an ocular portion of a user's eye.

Referring to FIG. 2, the electronic device 200 includes one or more processors 201 coupled with a memory 203, and one or more sensors 207. The one or more processors 201 is further coupled with a module or units 205 and database 209.

The electronic device 200 may correspond to various devices, such as a personal computer (PC), a tablet PC, a personal digital assistant (PDA), a mobile device, a palmtop computer, a laptop computer, a desktop computer, a communications device, dashboard, navigation device, a computing device, or any other machine capable of executing a set of instructions.

The processor 201 may be a single processing unit or a plurality of processing units, all of which could include multiple computing units. The processor 201 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 201 is configured to fetch and execute computer-readable instructions and data stored in the memory 203.

The memory 203 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The module(s) 205, and/or unit(s) 205 may include a program, a subroutine, a portion of a program, a software component, or a hardware component capable of performing a stated task or function. As used herein, the module(s), engine(s), and/or unit(s) may be implemented on a hardware component such as a server independently of other modules, or a module can exist with other modules on the same server, or within the same program. The module (s), engine(s), and/or unit(s) may be implemented on a hardware component such as processor one or more microprocessors, microcomputers, microcontrollers, digital signal processors, central processing units, state machines, logic circuitries, and/or any devices that manipulate signals based on operational instructions. The module (s), engine(s), and/or unit(s) when executed by the processor(s) may be configured to perform any of the described functionalities.

The database 209 may be implemented with integrated hardware and software. The hardware may include a hardware disk controller with programmable search capabilities or a software system running on general-purpose hardware. The examples of database are, but not limited to, in-memory database, cloud database, distributed database, embedded database and the like. The database amongst other things, serves as a repository for storing data processed, received, and generated by one or more of the processors, and the modules/engines/units.

The modules/units 205 may be implemented with an artificial intelligence (ΔI)/machine learning (ML) module that may include a plurality of neural network layers. Examples of neural networks include, but are not limited to, convolutional neural network (CNN), deep neural network (DNN), recurrent neural network (RNN), Restricted Boltzmann Machine (RBM). The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 201 control the processing of the input data in accordance with a predefined operating rule or artificial intelligence (AI) model stored in the non-volatile memory and the volatile memory. The predefined operating rule or artificial intelligence model is provided through training or learning.

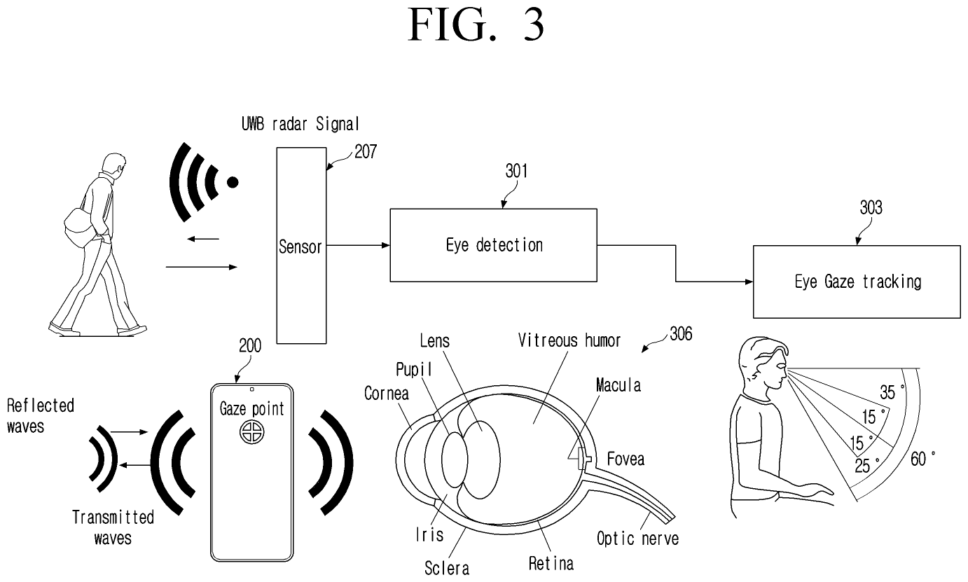

FIG. 3 illustrates an overall working of the imaging mechanism of the eye, according to an embodiment of the disclosure. Further, FIG. 3 will be explained by referring to FIG. 2. Further, the reference numerals were kept the same all over for ease of explanation.

Referring to FIG. 3 initially, the system is configured to determine whether the user is in the predefined or particular range of the electronic device. The sensors 207 may be configured to receive the sensor data. For example, a proximity sensor may be used to determine whether the user is in a particular range of the electronic device. After determining that the user is within the particular range, the sensor 207 directs radar signals on one or more portions 306 of the eye that is required to be captured. The radar signals may be, but are not limited to, the UWB radar waves or any high-frequency radio waves. The one or more portions include one or more layers (not shown).

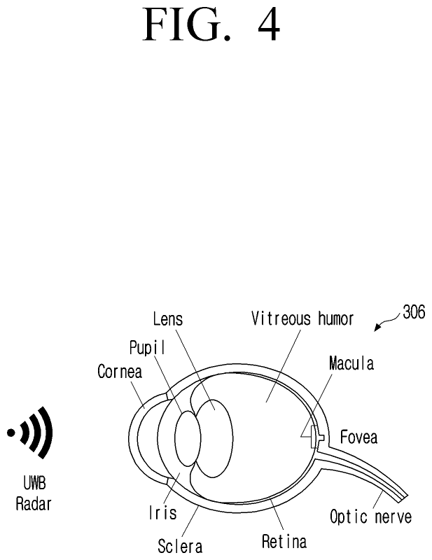

FIG. 4 shows various portions of the user's eye according to an embodiment of the disclosure.

Referring to FIG. 4, various portions of the eye may include the cornea, pupil, iris, sclera, retina, optic nerve, fovea, macula, vitreous humor, lens, and pupil.

Referring back to FIG. 3, after transmitting the UWB radar waves, at block 301 an eye detection mechanism is carried out. For doing so, the processors 201 may be configured to determine what amount of signals is being absorbed by the one or more portions 306 of the eye. This is done by measuring the amount of signals reflected by one or more portions 306 of the eye. In particular, the processor 201 may be configured to measure the amount of each of the signals reflected by each layer of the plurality of layers in the one or more portions 306. Further, a thickness (d) of each layer of the plurality of layers in the ocular portion 306 in response to the transmitted radar waves is determined. According to an embodiment of the disclosure, the thickness is determined based on a time difference (ΔT) between at least two consecutive reflected signals.

In an implementation, the eye tissue thickness (d) varies across different angles of UWB radar waves.

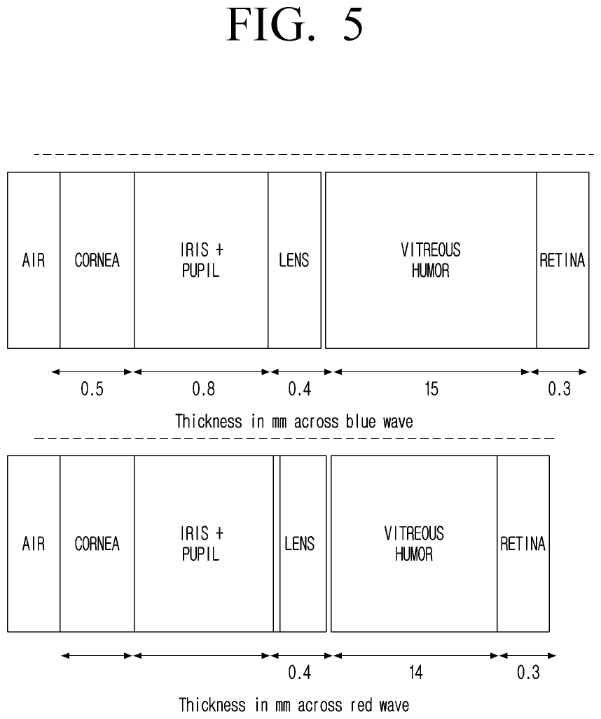

FIG. 5 illustrates the thickness of various portions of the eye, according to an embodiment of the disclosure.

Referring to FIG. 5, the variation in the eye tissue thickness may be calculated from reflected UWB waves and may be used to reconstruct the eye image. According to an embodiment of the disclosure the dielectric constant (c) is evaluated using the implementation based on Equation 1.

Dielectric Constant,ε≅[1+ΔT/(d/c)]² Equation 1
where d stands for the thickness of the concrete slab, c is the speed of light in free space, and ΔT is the time difference. Further, the distance (d) is d is given by the Equation 2.

D=c*T² Equation 2

According to an embodiment of the disclosure, using the reflected wave ΔT, and the thickness (d) of a particular tissue (e.g., eye lens), the dielectric constant (c) is estimated. The dielectric constant (c) refers to the relative permittivity of the eyes.

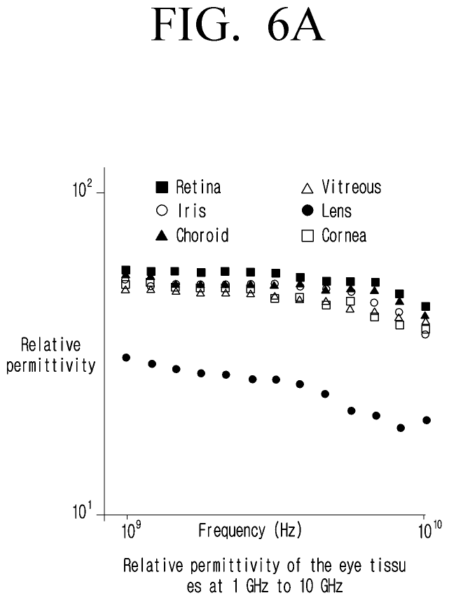

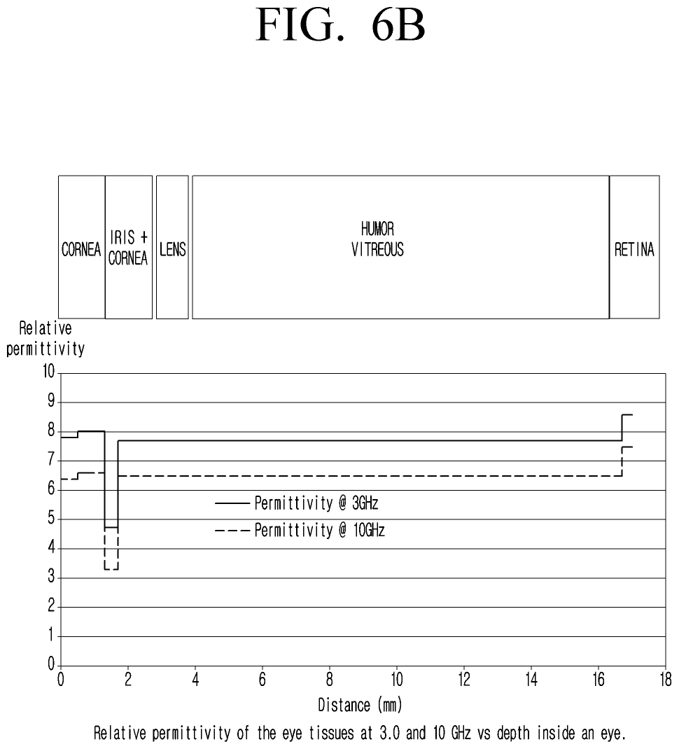

FIG. 6A illustrates the relation between relative permittivity and the eye tissue at different frequencies ranging from 1 GHz to 10 GHz according to an embodiment the disclosure.

Referring to FIG. 6A, UWB Radar frequency typically ranges from 3 GHz to 9 GHz. The graph illustrated in FIG. 6A shows the variation of permittivity in different layers of eye at different relevant frequencies.

Further, FIG. 6B shows a relation between relative permittivity of the eye tissues at 3.0 and 10 GHz vs depth inside an eye is shown according to an embodiment of the disclosure.

Referring to FIG. 6B, various eye tissues are present at various depth from the surface and this is captured in the figure. For example, cornea is the outermost layer of the eyeball and retina is the innermost layer.

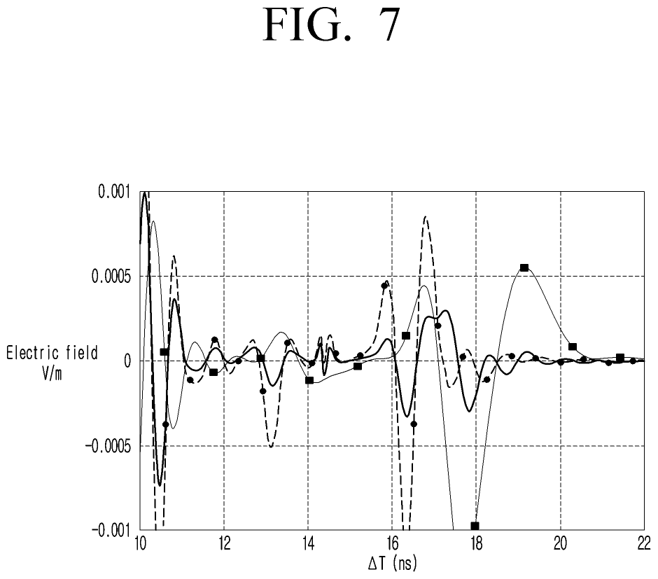

FIG. 7 illustrates a graph between the electric field and the reflected wave time delay (ΔT) according to an embodiment of the disclosure.

Referring to FIG. 7, different tissues will have different structural compositions and hence different electrical properties. The extent of absorption of any signal is dependent on electrical property of the tissue and the time it takes to traverse the tissue. The reflection data of the UWB waves that are directed at various angles are shown in red, blue, and gray rays in FIG. 7. This data along with permittivity values of eye tissues is used to find the thickness of the eye tissues thereby estimating the size of one or more portions 306 of the eye. Thus, the size of one or more portions 306 of the eye is being estimated basically based on the amount of signals absorbed by the eye. In particular, the thickness of the eye tissues is calculated from the amount of the signals absorbed by the eye which is then given to an AI/ML classifier to estimate the size of each of layer. As an example, any standard AI/ML classifier model may be utilized. Thereafter, the image of each layer of the plurality of layers is generated based on the classification. The image of each layer of the plurality of layers thus generated are combined to generate a complete image of the eye.

According another embodiment of the disclosure, the system, in particular, the processor 201 may be configured to classify each layer from the one or more layers of the one or more portions 306 based on the estimated size of each layer of the one or more portions 306. In an implementation, the AI/ML classifier may be used to classify each layer of the one or more portions 306.

The system may be used for various applications. The various application are, for example, but not limited to biometric authentication, 3D spatial modeling, eye gaze (UWB), 3D head tracking, AR pinning, AR Display Eye Gaze (UWB), Automatic Vision correction Eye Gaze (UWB), Natural Interaction, Eye Gaze (UWB), AR glasses and AR smart phones. An explanation will be made for a few of the applications in the forthcoming paragraphs.

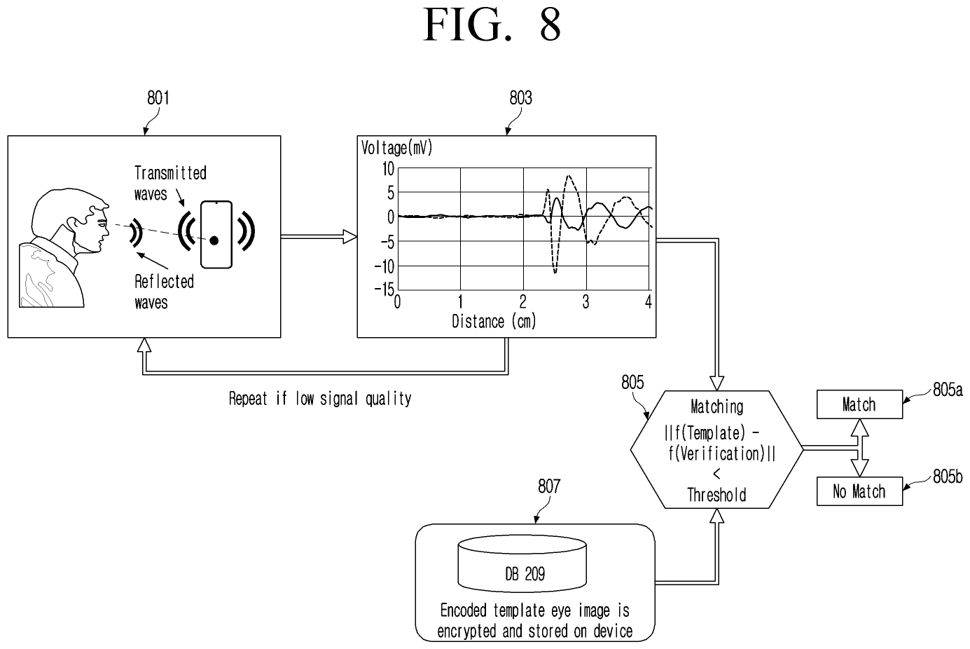

FIG. 8 illustrates an embodiment for biometric authentication, according to an embodiment of the disclosure.

Referring to FIG. 8, during the biometric registration, initially as shown at block 801, user's eye signal is recorded automatically using UWB radar. At block 803, the permittivity is estimated using the reflected signals to generate the eye image. The detailed process at blocks 801 and 803 are described in the above paragraphs and hence omitted for the sake of brevity. At block 805, the processor 201 of the system compares the generated image of the one or more portions 206 of the eye with a pre-stored image of the one or more portions of the user's eye to match with a predefined threshold value. In particular, the eye image that is recorded or generated during the verification is matched with a template eye image stored in DB 209 during the biometric registration as per block 805a. A state-of-the-art matching algorithm may be used for performing the matching process. If the generated image of the one or more portions 206 of the eye does not match the pre-stored image of the one or more portions of the user's eye in block 805b, then the system will not authenticate the user based on the result of the comparison. The encoded template eye image is encrypted and stored in the DB 209 in block 807.

According to the state of the art a simple technique to spoof fingerprint use apparatus is readily available. However, creating a replica of the eyeball is impossible. Accordingly, the disclosure provides a simple and uncomplex technique for eye image generation which can be utilized for various applications like biometric authentication.

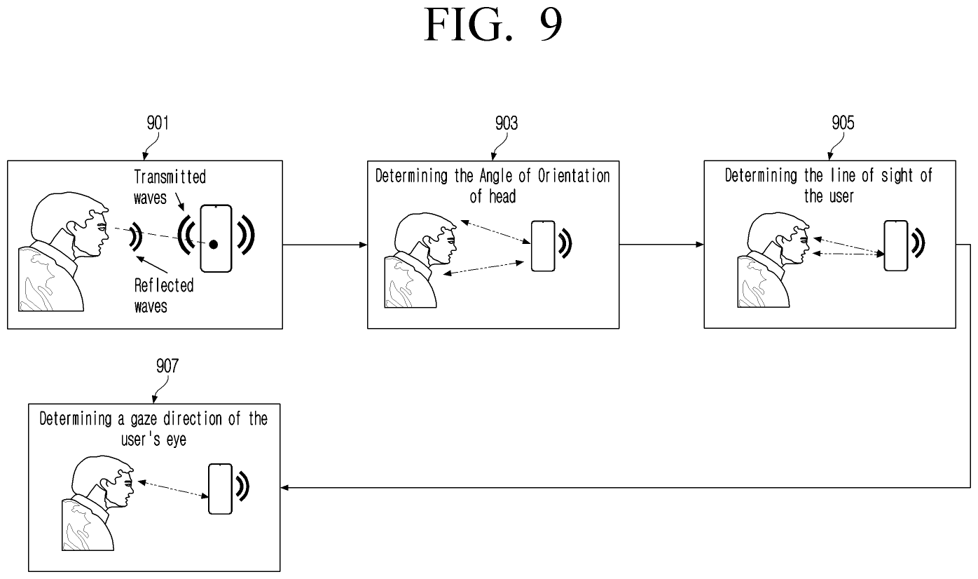

FIG. 9 illustrates an embodiment for determining a gaze direction, according to an embodiment of the disclosure.

Referring to FIG. 9, at block 901 an image of a head of a user is being captured via an imaging sensor that is included in the electronic device. At block 903, an angle of orientation of the head based on the captured image of the head is being determined. At block 905, a line of sight of the user's eye is determined based on the determined angle of orientation of the head of the user and the generated image of the user's eye. The generation of the user eye image is explained in the above paragraphs, hence omitted for the sake of brevity. At block 907, the gaze direction of the user's eye is determined based on the determined line of sight of the user's eye and the determined angle of orientation of the head. Accordingly, the disclosure provides a simple and uncomplex technique for eye image generation which can be utilized for various applications like determining the gaze direction. The determination of the gaze direction as explained above may be implanted in block 303 of FIG. 3.

The determined gaze direction may be utilized in automobiles where the system may detect if a driver is not looking at the road and thereby automatically switch to an auto-pilot mode. In another embodiment, the determined gaze direction may be utilized in smart watches where the smartwatch may turn on a display of the watch when it is determined that the person is looking at the smartwatch. In another example, the determined gaze direction may be utilized in an outdoor advertising board where the system may analyze the attention and focus of the consumer and accordingly may prefer to activate the display and perform the display operation. In another example, the determined gaze direction and eyes direction may be utilized in gaming where the eye and the head may be used as an immersive and handsfree gaming controller.

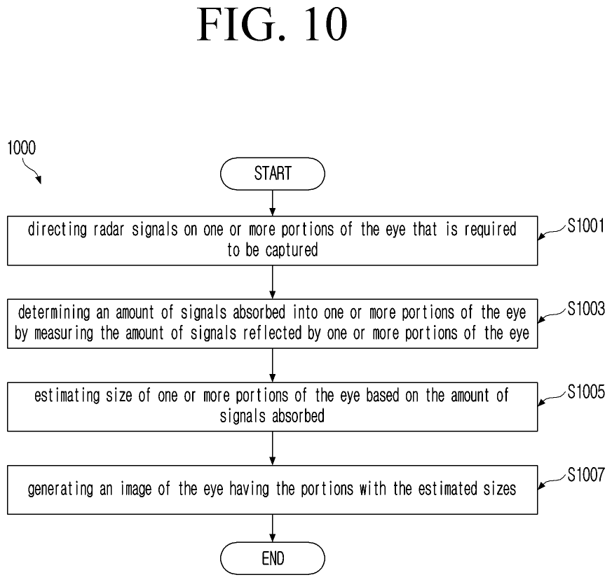

FIG. 10 illustrates an operational flow chart for generating an image of an ocular portion, according to an embodiment of the disclosure.

Referring to FIG. 10, the method 1000 may be implemented in system as shown in FIG. 2. Further, a detailed explanation of the mechanism performed by system was omitted here for the sake of brevity.

At operation 1001, the method 1000 includes initially determining whether a user is in a predefined range of the electronic device based on sensor data. Thereafter, directing radar signals on one or more portions of the eye that is required to be captured. Where the radar waves are directed on the one or more portions of the user's eye in response to the determination that the user is within the predefined range of the electronic device In an implementation, directing the radar signals on one or more portions of the eye includes transmitting radar signals on the one or more portions of the eye via at least one sensor that is included in the electronic device, wherein the one or more portions includes a plurality of layers.

At operation 1003, the method 1000 includes determining an amount of signals absorbed into one or more portions of the eye by measuring the amount of signals reflected by one or more portions of the eye. In an implementation, the measuring the amount of each of signals reflected by each layer of the plurality of layers in the one or more portions and the thickness of each layer of the plurality of layers in the one or more portions portion in response to the transmitted radar waves based on a time difference between at least two consecutive reflected signals.

At operation 1005, the method 1000 includes estimating size of one or more portions of the eye based on the amount of signals absorbed.

At operation 1007, the method 1000 includes generating an image of the eye having the portions with the estimated sizes.

According to an embodiment of the disclosure, the method 1000 further includes classifying each layer from the plurality of layers of the one or more portions based on the estimated size of each layer of the one or more portions. Thereafter, generating an image of each layer of the plurality of layers based on the classification and combining the generated image of each layer of the plurality of layers to generate the image of the eye.

According to another embodiment of the disclosure, the method 1000 further includes comparing the generated image of the one or more portions of the eye with a pre-stored image of one or more portions of the user's eye to match with a predefined threshold value; and thereafter authenticating the user based on the comparison.

According to another embodiment of the disclosure, the method 1000 further includes capturing an image of a head of a user via an imaging sensor included in the electronic device. Thereafter, determining an angle of orientation of the head based on the captured image of the head. The method 1000 may further include determining a line of sight of a user's eye based on the determined angle of orientation of the head of the user and the generated image of the one or more portions of the user's eye; and then determines a gaze direction of the user's eye based on the determined line of sight of the user's eye and the determined angle of orientation of the head.

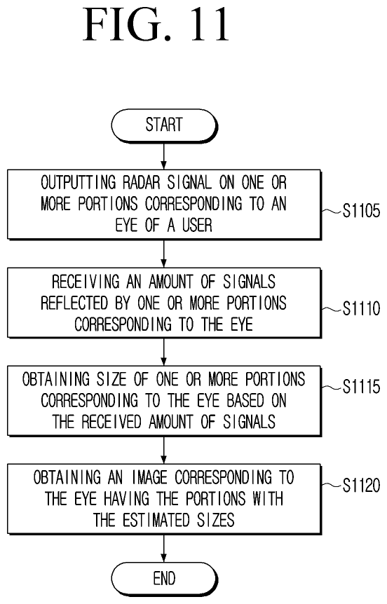

FIG. 11 illustrates an operational flow chart for image capturing method, according to an embodiment of the disclosure.

Referring to FIG. 11, an image capturing method in an electronic device includes outputting radar signal on one or more portions corresponding to an eye of a user at operation S1105, receiving an amount of signals reflected by one or more portions corresponding to the eye at operation S1110, obtaining size of one or more portions corresponding to the eye based on the received amount of signals at operation S1115 and obtaining an image corresponding to the eye having the portions with the estimated sizes at operation S1120.

The “outputting” may be described as directing, emitting, generating, projecting or transmitting.

The radar signal may be a signal related with Radio Detection and Ranging. The radar signal may include a plurality of signals. The radar signal may be described as light, wave, radar wave, signal, or communication signal.

The portion may be described as region or area.

The “an eye of a user” may be described as “eyes of a user” or “one eye of a user”.

The “receiving” may be described as determining or identifying.

The “obtaining size” may be described as “estimating size” or “identifying size”.

The “size” may be described as size value, size information or size data.

The “obtaining an image” may be described as “generating an image”.

According to an embodiment of the disclosure, the method may include outputting radar signal and receiving an amount of signals based on at least one sensor in the electronic device.

According to an embodiment of the disclosure, the method may include outputting radar signal through a first sensor among the at least one sensor. The method may include receiving an amount of signals through a second sensor among the at least one sensor. The first sensor may be different from the second sensor.

“through” may be described as “via” or “from”.

The at least one sensor may be a radar sensor, laser sensor, projection sensor or signal output unit.

The “sensor data” may be “sensing data” or “sensing information”.

The at least one sensor may obtain sensing data. The method may include outputting the radar signal based on the at least one sensor.

The outputting radar signal on one or more portions corresponding to the eye may include outputting the radar signal on the one or more portions corresponding to the eye through at least one sensor that is included in the electronic device. The one or more portions may include a plurality of layers.

The receiving amount of signals may include receiving the amount of each of signals reflected by each layer of the plurality of layers in the one or more portions. The obtaining the size of one or more portions corresponding to the eye may include obtaining a time difference between at least two consecutive reflected signals based on the received the amount of each of signals and identifying a thickness of each layer of the plurality of layers in the one or more portions based on the time difference between the at least two consecutive reflected signals.

The method may include determining whether the user is in a predefined range of the electronic device based on a sensor data. The radar signal may be output on the one or more portions corresponding to the eye in response to the determination that the user is within the predefined range of the electronic device.

The radar signal may include at least one of high frequency radio waves and ultrawide band (UWB) waves.

The high frequency radio wave may include frequency radio waves corresponding to a pre-determined range.

The obtaining the image corresponding to the eye may include classifying each layer from the plurality of layers of the one or more portions based on the estimated size of each layer of the one or more portions, obtaining a sub image corresponding to each layer among the plurality of layers based on the classification and obtaining the image corresponding to the eye by combining the sub image corresponding to each layer.

The classifying each layer may be described as “obtaining each layer”.

The sub image, corresponding to each layer among the plurality of layers, may include a plurality of sub images.

After obtaining the sub images, the method may include combining the sub images. For example, the method may include a first sub image corresponding to a first layer among the plurality of layers. The method may include a second sub image corresponding to a second layer among the plurality of layers. The method may include combining the first sub image and the second sub image. The method may include obtaining the image corresponding to the eye based on the combination result.

The method may include obtaining similarity value between the image corresponding to the eye and a pre-stored image of one or more portions corresponding to the eye, comparing the similarity value with a predefined threshold value and authenticating the user based on the comparison.

The similarity value may be described as similarity score or correlation coefficient.

For example, based on the similarity value being greater than the predefined threshold value, the method may authenticating the user.

The image corresponding to the eye may be a first image and the method may include capturing a second image corresponding to a head of the user through an imaging sensor included in the electronic device, determining an angle of orientation corresponding the head based on the second image corresponding to the head, determining a line of sight corresponding to the eye based on the determined angle of orientation corresponding to the head and the first image of the one or more portions corresponding to the eye and determining a gaze direction corresponding to the eye based on the determined angle of orientation corresponding the head and the determined line of sight of corresponding to the eye.

The “capturing a second image” may be described as “obtaining a second image”.

The “imaging sensor” may be a “camera”.

The “angle of orientation” may be described as “angle information” or “angle coordinate”.

The one or more portions corresponding to the eye may include an ocular portion of the eye.

The “ocular portion” may be described as “ocular region”, “ocular segment” or “ocular section”.

The ocular portion may include a plurality of layers in the ocular portion of the eye.

Some example embodiments disclosed herein may be implemented using processing circuitry. For example, some example embodiments disclosed herein may be implemented using at least one software program running on at least one hardware device and performing network management functions to control the elements.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

While the disclosure has been shown and described above with reference to various embodiments thereof, it will be understood by those skilled in the art that various changes in form and details may be made therein without departing from the spirit and scope of the disclosure as defined by the appended claims and their equivalents.

What is claimed is:

1. An image capturing method in an electronic device, the image capturing method comprising:
outputting a radar signal on one or more portions of a user's eye;
receiving an amount of signals reflected by one or more portions corresponding to the eye;
obtaining a size of one or more portions corresponding to the eye based on the received amount of signals; and
obtaining an image corresponding to the eye having the portions with the obtained sizes.

2. The method as claimed in claim 1,
wherein the outputting of the radar signal on one or more portions of the eye comprises outputting the radar signal on the one or more portions corresponding to the eye through at least one sensor that is included in the electronic device, and
wherein the one or more portions includes a plurality of layers.

3. The method as claimed in claim 2,
wherein the receiving of the amount of signals comprises receiving the amount of each of signals reflected by each layer of the plurality of layers in the one or more portions, and
wherein the obtaining of the size of the one or more portions corresponding to the eye comprises:
obtaining a time difference between at least two consecutive reflected signals based on the received the amount of each of signals, and
identifying a thickness of each layer of the plurality of layers in the one or more portions based on the time difference between the at least two consecutive reflected signals.

4. The method as claimed in claim 1, further comprising:
determining whether the user is in a predefined range of the electronic device based on a sensor data,
wherein the radar signal is output on the one or more portions corresponding to the eye in response to the determination that the user is within the predefined range of the electronic device.

5. The method as claimed in claim 4, wherein the radar signal includes at least one of high frequency radio waves and ultrawide band (UWB) waves.

6. The method as claimed in claim 2, wherein the obtaining the image corresponding to the eye comprises:
classifying each layer from the plurality of layers of the one or more portions based on the obtained size of each layer of the one or more portions;
obtaining a sub image corresponding to each layer among the plurality of layers based on the classification; and
obtaining the image corresponding to the eye by combining the sub image corresponding to each layer.

7. The method as claimed in claim 1, further comprising:
obtaining similarity value between the image corresponding to the eye and a pre-stored image of one or more portions corresponding the eye;
comparing the similarity value with a predefined threshold value; and
authenticating the user based on a result of the comparison.

8. The method as claimed in claim 1,
wherein the image corresponding to the eye is a first image, and
wherein the method further comprises:
capturing a second image corresponding to a head of the user through an imaging sensor included in the electronic device;
determining an angle of orientation corresponding the head based on the second image corresponding to the head;
determining a line of sight corresponding to the eye based on the determined angle of orientation corresponding to the head and the first image of the one or more portions corresponding to the eye; and
determining a gaze direction corresponding to the eye based on the determined angle of orientation corresponding the head and the determined line of sight of corresponding to the eye.

9. The method as claimed in claim 1, wherein the one or more portions corresponding to the eye includes an ocular portion of the eye.

10. The method as claimed in claim 9, wherein the ocular portion includes a plurality of layers in the ocular portion of the eye.

11. An electronic device, comprising:
at least one sensor; and
at least one processor;
wherein the at least one processor is configured to:
through the at least one sensor, output radar signals on one or more portions of a user's eye,
through the at least one sensor, receive an amount of signals reflected by one or more portions corresponding to the eye,
obtain a size of one or more portions corresponding to the eye based on the received amount of signals, and
obtain an image corresponding to the eye having the portions with the obtained sizes.

12. The electronic device as claimed in claim 11,
wherein the at least one processor is further configured to, through the at least one sensor, output the radar signal on the one or more portions corresponding to the eye through at least one sensor that is included in the electronic device, and
wherein the one or more portions includes a plurality of layers.

13. The electronic device as claimed in claim 12, wherein the at least one processor is further configured to:
through the at least one sensor, receive the amount of each of the signals reflected by each layer of the plurality of layers in the one or more portions,
obtain a time difference between at least two consecutive reflected signals based on the received the amount of each of signals, and
identify a thickness of each layer of the plurality of layers in the one or more portions based on the time difference between the at least two consecutive reflected signals.

14. The electronic device as claimed in claim 11,
wherein the at least one processor is further configured to determine whether the user is in a predefined range of the electronic device based on a sensor data, and
wherein the radar signal is output on the one or more portions corresponding to the eye in response to the determination that the user is within the predefined range of the electronic device.

15. The electronic device as claimed in claim 14, wherein the radar signal includes at least one of high frequency radio waves and ultrawide band (UWB) waves.

16. The electronic device as claimed in claim 11, wherein the processor is further configured to obtain the size of the one or more portions by estimating a size of the one or more portions based on the amount of the signals.
